(19) United States
(12) Patent Application Publication
(10) Pub. No.: US 2026/0204446 A1
(43) Pub. Date: Jul. 16, 2026

(54) PACKAGING FOR TRANSPORTING AND/OR STORING RADIOACTIVE MATERIALS, COMPRISING A SIMPLIFIED RADIOLOGICAL PROTECTION DEVICE, REDUCING THE RISKS OF RADIOLOGICAL LEAKS

(71) Applicant: ORANO NUCLEAR PACKAGES AND SERVICES, Montigny-le-Bretonneux (FR)

(72) Inventors: Hervé RIPERT, PARIS (FR); Yannick BRESSON, VERSAILLES (FR); Thibault LAURENT, VERSAILLES (FR); Frédérick BORDES, GUYANCOURT (FR)

(21) Appl. No.: 19/132,445

(22) PCT Filed: Dec. 5, 2023
(86) PCT No.: PCT/FR2023/051923

§ 371 Date: May 23, 2025

(30) Foreign Application Priority Data
Dec. 9, 2022 (FR) 2213128

(51) Int. Cl. G21F 5/12; G21F 5/008

(52) U.S. Cl. CPC G21F 5/12; G21F 5/008

(57) ABSTRACT

A container for transporting and/or storing radioactive materials, comprising a body delimiting a cavity for housing the radioactive materials, the container including at least one radiological protection enclosure formed by enclosure wall elements, each enclosure delimiting with its elements a single space wherein a radiological protection device (28) comprising a plurality of prefabricated blocks arranged in succession along a given direction, so as to face each other, is disposed. At least several blocks are each held on at least one of the elements by at least one holding member cooperating with this block and with the at least one of the associated enclosure wall elements.

### TECHNICAL FIELD

The present invention relates to the field of containers for transporting and/or storing radioactive materials, for example nuclear fuel assemblies or radioactive waste.

More specifically, the invention relates to a container comprising a radiological protection device formed by a plurality of prefabricated blocks.

### PRIOR ART

From the prior art, it is known to provide a container equipped with one or more radiological protection devices arranged around a cavity for housing the radioactive materials, or in the lid for closing this container. The function sought with this device lies in protection against gamma radiation, and/or in neutron absorption in order to comply with regulatory radiological criteria about the container, when it is loaded with radioactive materials.

To do this, one solution consists in inserting radiological protection elements into an enclosure, for example an enclosure delimiting an annular space centered on the longitudinal central axis of the container, around the cavity for housing the radioactive materials. These radiation protection elements usually take the form of prefabricated blocks, which, thanks to a cold gap, can be introduced into this space. This cold gap also allows the thermal expansion of the radiological protection material, and thus limits the thermomechanical stresses of these blocks on the parts of the container defining the space concerned.

During transport operations performed with this type of container, and during their handling, radiation protection blocks can move and slide relative to each other in the designated space. The accumulated movements between these blocks can result locally, between two adjacent blocks, in the appearance of a gap of an unacceptable value in relation to radiological leakages.

A solution to this problem has already been developed by the Applicant, and it is disclosed in document FR 3 114 907 A1. Although this solution correctly meets the stated objective of reducing radiological leakage risks, there is however still a need to optimize its design, in particular to facilitate the manufacture and installation of the radiological protection device.

### DESCRIPTION OF THE INVENTION

To meet this need, the invention relates to a container for transporting and/or storing radioactive materials, the container comprising a container body formed by a lateral body, a bottom and a removable lid, the bottom and the lid being spaced apart from each other along a longitudinal central axis of the container, and the body delimiting a cavity for housing the radioactive materials, the container including at least one radiological protection enclosure formed by enclosure wall elements, each radiological protection enclosure delimiting with its enclosure wall elements a single space wherein a radiological protection device is disposed.

According to the invention, the radiological protection device includes a plurality of prefabricated radiological protection blocks arranged in succession along a given direction of the container, so as to face each other in said direction, within said single space.

Furthermore, at least several of said plurality of blocks are each held on at least one of the enclosure wall elements by at least one holding member cooperating with this block and with said at least one of the associated enclosure wall elements.

Finally, said plurality of prefabricated blocks defines, within said single space, several inter-block gaps along said given direction, each inter-block gap being defined between two blocks arranged in direct succession along said direction.

The invention advantageously makes it possible to limit or prohibit in a simple way the spacing between the radiological protection blocks in the radiological protection enclosure, having the effect of a substantial reduction of the radiological leakage risk between these prefabricated blocks.

The presence of inter-block gaps is not detrimental to the radiological protection function, because any accumulation remains limited, or even reduced to none thanks to the holding members of these blocks. On the other hand, the inter-block gaps allow the thermal expansion of the prefabricated blocks, without risking constraining the wall elements of the enclosure wherein they are located too severely.

Moreover, for the embodiment of the invention, the shape of the prefabricated radiological protection blocks can advantageously remain simple, therefore inexpensive. Furthermore, the holding of the blocks on the enclosure wall element(s), via the holding members, is an easy-to-implement and inexpensive solution.

It is noted that another advantage of the proposed solution lies in obtaining an indexing of the prefabricated radiological protection blocks, relative to the wall elements of the enclosure. This proves to be useful, for example, when the blocks are produced using different materials, and judiciously positioned in the enclosure to adapt locally to the radiation level observed.

Finally, another advantage of the invention is that of being able to produce a mechanical assembly of the elements from prefabricated components. Indeed, prefabricating the radiological protection blocks, in parallel with manufacturing the other components of the container such as its lid, its lateral body, etc., makes it possible to reduce the manufacturing time of the container. In particular, it is not necessary to provide a step of casting the resin, nor is it necessary to perform degassing thereof.

The invention moreover provides at least one of the following optional features, taken alone or in combination.

According to a first preferred embodiment of the invention, the radiological protection enclosure is located at the lid and it is formed by enclosure wall elements of the lid, said single space extending over a given angular amplitude along a circumferential direction of the enclosure and the container, first prefabricated radiation protection blocks being arranged in succession along the circumferential direction so as to face each other in said direction.

Moreover, at least several of said first blocks are each held on at least one of two enclosure wall elements of the lid delimiting said single space along a longitudinal direction of the enclosure and the container, respectively in the two opposite directions of this direction, holding being carried out by a first holding member housed in a first orifice of this first block, and also housed in a first orifice made on at least one of the two associated enclosure wall elements.

Preferably, each first block held by its first associated holding member is also held by a second holding member housed in a second orifice of this first block, and also housed in a second orifice made on at least one of the two associated enclosure wall elements, said second orifice in the first block being preferably radially spaced apart from the first orifice in this first block.

Preferably, the first and/or second orifice in the first held block is of oblong shape, the length of which is oriented radially or substantially radially, and preferably only that of the two orifices which is radially farthest away from the longitudinal central axis. This makes it possible to allow thermal expansion of the first blocks, in the radial direction. This oblong shape could alternatively be adopted for the two orifices, or only for that located radially closest to the longitudinal central axis of the container. In the same way, when each first block only has the first orifice and not the second, the first can be of oblong shape extending lengthwise in the radial or substantially radial direction.

When the orifices mentioned above are not of oblong shape, they preferably adopt a circular shape.

Moreover, in this first preferred embodiment of the invention as well as in all other embodiments, it is noted that each of the orifices is either blind, or through. The holding members are, for their part, preferably pins, rods, tie rods, bolts, rivets, or any other similar member.

According to one possibility provided by this first embodiment, said single space also houses second prefabricated radiological protection blocks in succession along the circumferential direction so as to face each other in said direction, and at least several of said second blocks are each held on at least one of the two enclosure wall elements of the lid by said first holding member housed in a first orifice of this second block, and also housed in said first orifice made on at least one of the two associated enclosure wall elements. Moreover, each first block covers, along the longitudinal direction, an inter-block gap in said circumferential direction between two second blocks in direct succession, and vice versa.

This configuration advantageously makes it possible to form two rows of stacked blocks along the longitudinal direction, to drastically limit leakages through the inter-block gaps. It is preferably provided here to use the same first holding members to hold both the first and the second prefabricated blocks, but separate holding members could be provided for the second blocks, without leaving the scope of the invention.

In this regard, it is indicated that, as for the first held blocks, the second held blocks could be equipped with a second orifice. These first and second orifices of the second prefabricated blocks preferably have the same design as that of the first and second orifices of the first held blocks.

Moreover, it is noted that the first and second blocks preferably all have an identical design, the second blocks being arranged in said single space in an inverted position relative to the position of the first blocks. This significantly reduces manufacturing costs, and greatly limits risks of assembly error of the blocks in the radiation protection enclosure.

To do this, preferably, each first and second block has an imaginary radial midline, delimiting, on either side circumferentially of this imaginary line, two block portions including a holding portion comprising the first orifice, this first orifice being arranged along an imaginary radial midline of this holding portion. The same applies when a second orifice is also provided on the first and second blocks.

Preferably, said single space extends over an angular amplitude of 360° along the circumferential direction. Nevertheless, it could alternatively involve several circumferentially segmented enclosures to recreate radiological protection over 360, with in this case, each enclosure extending over an angular amplitude of less than 360° and housing its own radiological protection device according to the principle of the invention. In this first preferred embodiment of the invention, the first blocks thus form a ring using the blocks forming angular sectors of this ring, spaced apart from each other at least in the case of some, by circumferential inter-block gaps. The same applies to the second blocks, the latter being preferably arranged in phase opposition relative to the first blocks, so as to cover the circumferential inter-block gaps.

The following preferred embodiments apply to a radiological protection enclosure which is located around the cavity for housing the radioactive materials.

According to a second preferred embodiment of the invention, the enclosure wall elements are arranged about the longitudinal central axis, said single space extending over a given height along the longitudinal direction of the container, prefabricated radiological protection blocks being arranged in succession along the longitudinal direction so as to face each other in said direction.

Moreover, at least several of said blocks are each held on at least one of two enclosure wall elements delimiting said single space along a radial direction of the enclosure and the container, respectively in the two opposite directions of this direction, holding being carried out by a holding member housed in an orifice of the block, and also housed in an orifice made on at least one of the two associated enclosure wall elements.

Preferably, the two enclosure wall elements respectively form an inner shroud and an outer shroud centered on the longitudinal central axis. The inner shroud could be placed around the lateral container body, or formed by said body.

Preferably, the blocks in direct succession in the longitudinal direction partially overlap with each other along the radial direction, so as to limit radiological leakages in said radial direction. An alternative would be to provide two longitudinal rows of blocks radially overlapping each other, so as to obtain a principle identical or similar to that described for the first preferred embodiment, with said first and second blocks.

According to a third preferred embodiment of the invention, the radiological protection enclosure comprises two enclosure wall elements each adopting an annular structure form and being stacked along the longitudinal direction, each annular structure centered on the longitudinal central axis comprising a radially outer portion, and a radial portion extending radially from the radially outer portion toward the longitudinal central axis and delimiting said single space along the longitudinal direction, the annular structure delimiting an opening opposite the radial portion along the longitudinal direction, this opening being sealed by the radial portion of the other annular structure which is stacked.

Furthermore, said single space extends over a given angular amplitude along a circumferential direction of the enclosure and the container, first prefabricated radiological protection blocks being arranged in succession along the circumferential direction so as to face each other in said direction, and at least several of said first blocks are each held on at least one of the two enclosure wall elements in annular structure form, holding being carried out by a first holding member housed in an orifice of the first block, and also housed in a first orifice made on at least one of the two associated wall elements, preferably on the radial portion of at least one thereof.

According to one possibility provided with this third preferred embodiment of the invention, said single space also houses second prefabricated radiological protection blocks arranged in succession along the circumferential direction so as to face each other in said direction. At least several of said second blocks are each held on at least one of the two enclosure wall elements in annular structure form, by a second holding member housed in an orifice of this second block, and also housed in a second orifice made on at least one of the two associated wall elements, preferably on the radial portion of at least one thereof. Moreover, each first block covers, along the radial direction, an inter-block gap in said circumferential direction between two second blocks in direct succession, and vice versa. While the first and/or second holding members implemented in this third embodiment may be of the type mentioned above, they preferably take the form of pins or through rods. In the latter case, each rod can pass through a block of each of several radiological protection enclosures arranged in succession along the longitudinal direction of the container. Other advantages and features of the invention will appear in the non-limiting detailed description below.

### BRIEF DESCRIPTION OF THE DRAWINGS

This description will be made with regard to the appended drawings, wherein:

FIG. 1 shows a schematic longitudinal axial sectional view of a container for transporting and/or storing radioactive materials, according to the invention;

FIG. 2 shows a top view of the lid of the container shown in the previous figure, in the form of a first preferred embodiment of the invention;

FIG. 3 shows a sectional view taken along the line III-III of FIG. 2;

FIG. 4 represents a sectional view taken along the line IV-IV of FIG. 3;

FIG. 5 shows a sectional view taken along the line V-V of FIG. 4;

FIG. 6 is a top view of one of the first prefabricated radiation protection blocks implemented in the first preferred embodiment of the invention;

FIG. 7 is a top view of one of the second prefabricated radiological protection blocks implemented in the first preferred embodiment of the invention;

FIG. 8 is a partial longitudinal sectional view of a container according to a second preferred embodiment of the invention;

FIG. 9 shows a cross-sectional view of the container, presented according to an alternative to the second embodiment of FIG. 8;

FIG. 10 shows a partial longitudinal half-sectional view of a container according to a third preferred embodiment of the invention, this FIG. 10 corresponding to the section taken along the line X-X of FIG. 11;

FIG. 11 shows a partial cross-sectional view taken along the line XI-XI of FIG. 10;

FIG. 12 is a partial perspective view of one of the annular structures forming one of the radiological protection enclosures on the container shown in FIGS. 10 and 11; and

FIG. 13 shows a cross-sectional view of the container, presented according to an alternative to the third embodiment of FIGS. 10 to 12.

### DETAILED DISCLOSURE OF PREFERRED EMBODIMENTS

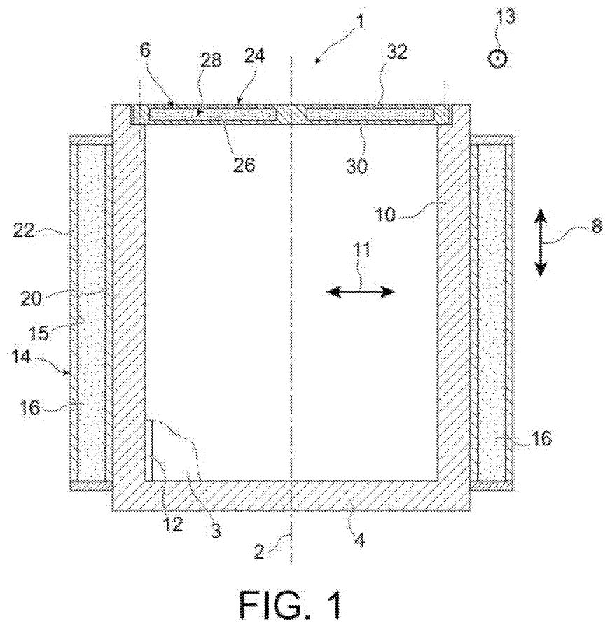

With reference firstly to FIG. 1, a container 1 for transporting and/or storing radioactive materials, such as nuclear fuel assemblies 3 or radioactive waste (shown only partially and schematically in FIG. 1), is shown.

This container 1 is shown in a vertical storage/warehousing position, wherein its longitudinal central axis 2 is oriented vertically. It rests on a container bottom 4, opposite a removable lid 6 along the direction of the height 8, parallel with the longitudinal axis 2. The direction of the height 8, represented schematically in FIG. 1, thus corresponds to the longitudinal direction of the container, while its radial direction is represented by the arrow 11, and its circumferential/tangential direction by the arrow 13. These directions 8, 11, 13 are associated with the container 1 as a whole, but also with each of its components, in particular with the radiological protection enclosures which will be described hereinafter.

Between the bottom 4 and the lid 6, the container 1 includes a lateral body 10 extending about the axis 2, and internally delimiting a cavity 12 for housing the radioactive materials 3. This cavity 12 can form a containment enclosure intended to receive the radioactive materials, for example arranged in a storage basket also located in the containment enclosure. Alternatively, the containment enclosure is defined entirely by a case, also known as “canister”, placed in the aforementioned cavity 12. The latter is closed axially at the top by the lid 6, and at the bottom by the bottom 4, which can be made of one piece with the lateral body 10 of the container. These elements 4, 6 and 10 indeed form the body of the container, designated in particular to ensure the mechanical strength of the container in the event of a fall, so as to retain the tightness of the containment enclosure. At its periphery and around the axis 2, the container 1 is also equipped with a radiological protection enclosure 14 delimiting an annular space wherein a neutron protection device 16 is arranged. This device 16 may be conventional, or comply with the principle of the invention, as will be explained in detail hereinafter, in a second preferred embodiment of the invention. It is noted that the enclosure 14 is formed using several enclosure wall elements delimiting the annular space 15, in particular an inner shroud 20 and an outer shell 22, both centered on the axis 2. Here, the inner shroud 20 is a part added around the lateral body 10 of the container, but alternatively, the inner delimitation of the annular space 15 could be created directly by the outer surface of the lateral body 10. The outer shell 22 in turn forms the lateral periphery of the container 1.

The radiological protection device 16 is here a neutron protection device, produced for example using prefabricated blocks stacked along the direction 8 in the annular space 15. Each prefabricated radiological protection block is preferably made of cast resin. This resin may comprise boron or any other neutrophagous element, i.e. neutron-absorbing elements. “Neutron-absorbing elements” means elements which have an effective cross-section greater than 100 barn for thermal neutrons.

The elements 10, 20, 22 of the container may be metallic, for example made of steel or cast iron. In the annular space 15, also referred to as inter-shroud space, preferably, no heat conductors are provided in addition to the protection blocks. This particular case corresponds to containers intended for transporting radioactive materials releasing little, or no, thermal power. “Heat conductors” means conductors conventionally implemented in containers, generally arranged alternately with the neutron protection blocks and connecting the inner shroud 20 to the outer shell 22. Nevertheless, heat conductors in the form of annular disks could be envisaged. The blocks then alternate with the thermal conduction disks in the direction 8.

At the lid 6, another radiological protection enclosure 24 is provided, which is here the only one inside the lid, and which delimits the single annular space 26 centered on the axis 2. In this space 26, in the form of a ring, a neutron protection device 28 is arranged, specific to the present invention and which is the subject of a first preferred embodiment thereof.

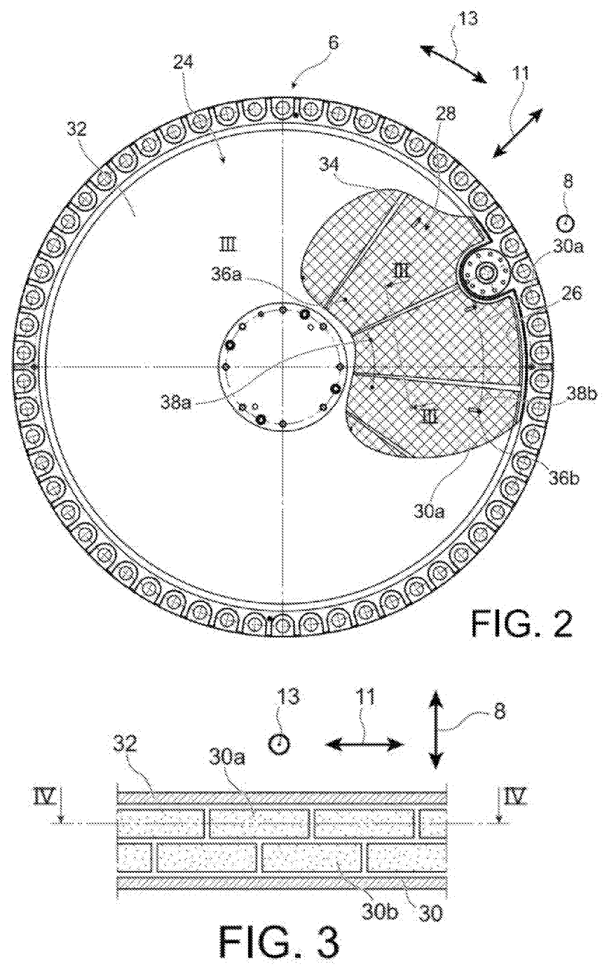

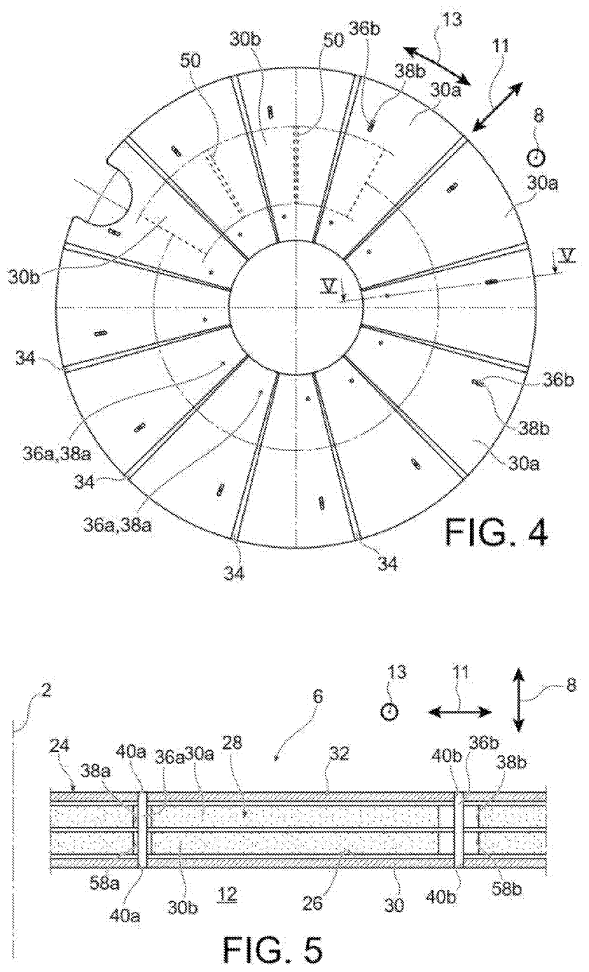

With reference collectively to FIGS. 1 to 7, the enclosure 24 of the first embodiment is formed using several wall elements of the lid, in particular an inner cowl 30 and an outer cowl 32 spaced apart from each other along the direction 8, and each orthogonal to said direction. These cowls 30, 32 could respectively form the axially inner and outer walls of the lid, or be housed therein. Other enclosure wall elements are provided to radially close the single annular space 26, thus extending continuously over 360° about the axis 2, on which the lid 6 is also centered. Alternatively, several radiological protection enclosures in the form of distinct angular sectors could be arranged adjacent along the circumferential direction 13, without leaving the scope of the invention. In such a case, each single space 26, associated with a given enclosure 24, then extends along an angular amplitude of less than 360° along the circumferential direction 13.

The radiological protection device 28 is here a neutron protection device, produced using prefabricated radiation protection blocks 30a, 30b. Each prefabricated block 30a, 30b is preferably made of cast resin. Then, to size them, a final cutting is carried out on the cast resin, for example with a water jet. This resin may comprise boron or any other neutrophagous element, with the meaning mentioned above.

The enclosure wall elements 30, 32 of the lid of the container may be metallic, for example made of steel or cast iron. In the single annular space 26, in the form of a ring centered on the axis 2, preferably, no heat conductors are provided in addition to the protection blocks. This space 26 is indeed preferably only occupied by the blocks 30a, 30b, and by their holding members which will be described hereinafter.

In this first preferred embodiment of the invention, the blocks are divided into first blocks 30a forming a first annular row of blocks centered on the axis 2, and into second blocks 30b forming a second annular row of blocks centered on the axis 2. The two rows, each comparable to a ring formed by blocks each forming an angular sector of said ring, are thus stacked on top of each other inside the space 26, along the direction 8. In the figures, the row of first blocks 30a corresponds to that located farthest away from the cavity 12 for housing the radioactive materials.

With respect to this annular row of first blocks 30a, they are therefore arranged in succession along the circumferential direction 13, so as to face each other in said direction, within the single space 26. At least several of these first blocks 30a define circumferential inter-block gaps 34 between each other, each corresponding to a space left empty between two blocks 30a in direct succession along the direction 13. Preferably, such a gap 34 is provided on either side of each block 30a of the device 28, even though some blocks could be in contact with each other in the direction 13, without leaving the scope of the invention. All the first blocks 30a are preferably identical or substantially identical. Generally, each block 30a is made of one piece in angular sector form, extending over an amplitude for example of the order of 15 to 45, flattened along the direction 8.

One of the particularities of the invention lies in the implementation of means for limiting/preventing circumferential spacing between the adjacent first blocks 30a, and thus preventing the accumulation of such spacings from resulting in neutron leakages of an unacceptable level between two blocks 30a in direct succession. In other words, the invention provides a practical solution making it possible to retain all or part of the inter-block gaps 34, and to ensure that in the event of any accumulation between the latter, the extent of the accumulation remains controlled and acceptable.

For this purpose, it is provided that several first blocks 30a, and preferably all or almost all of them, are each held on at least one of the two cowls 30, 32 delimiting the space 26 along the direction 8, respectively in the two opposite directions of this direction, namely upward and downward. Thanks to this implementation, in addition to limiting the risks of accumulation of the circumferential inter-block gaps 34, connecting these blocks 30a to one or both cowls 30, 32 of the lid makes it possible to obtain and retain an indexing of these blocks relative to the other elements 30, 32 of the lid.

For each of the first blocks 30a concerned, they are held by a first holding member 36a housed in a first orifice 38a of this first block, and also housed in a first orifice 40a made on at least one of the two cowls 30, 32. Preferably, the holding member 36a is a pin of circular cross-section oriented along the direction 8. It is fastened at its two opposite ends onto the two cowls 30, 32, in the orifices 40a thereof, and it passes through the first orifice 38a of the block 30a with or without a gap.

This first holding member 36a is preferably located near an inner radial end of the block 30a. It makes it possible to limit/prevent its circumferential movement, respectively relative to each of the first two blocks 30a located on either side thereof in the circumferential direction 13.

To reinforce the holding and indexing of each of these first blocks 30a held by the first member 36a, each block is also held by a second holding member 36b housed in a second orifice 38b of this first block, and also housed in a second orifice 40b made on each of the two cowls 30, 32. The second orifice 38b through the block 30a is spaced radially apart from the first orifice 38a, being located near an outer radial end of this block. It is therefore entirely traversed by the second holding member 36b, also preferably in the form of a pin of circular cross-section oriented along the direction 8. This second member 36b is fastened at its two opposite ends onto the two cowls 30, 32, in the orifices 40b thereof, and it passes with a gap through the second orifice 38b of the block 30a, the shape of which is oblong of radially or substantially radially oriented length. This configuration allows the thermal expansion of the block 30a, along the radial direction 11.

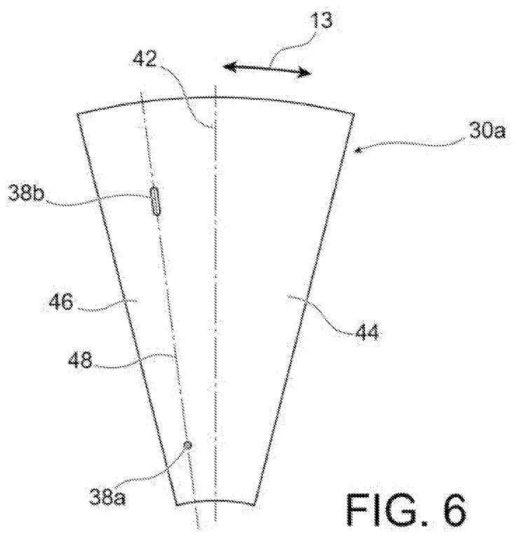

As indicated above, the first blocks 30a all have an identical or substantially identical design, to facilitate their manufacture. As seen in FIG. 6, the first block 30a has an imaginary radial midline 42, delimiting, on either side thereof along the direction 13, a solid portion 44 and a holding portion 46 comprising the two orifices 38a, 38b. These two portions 44, 46 form two block half-sectors, of the same angular amplitude. The two through holes 38a, 38b, of axes orthogonal to the plane wherein this ring sector 30a is inscribed, are arranged along an imaginary radial midline 48 of the holding portion 46.

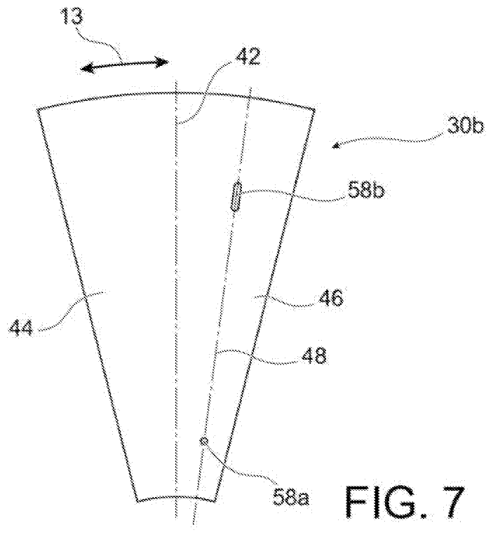

This specific design makes it possible, when the block 30a is inverted, to form a second block 30b for producing the second annular row, wherein the position of the holding orifices within the second blocks 30b is inverted relative to that within the first blocks 30a. Indeed, as seen in FIG. 7 showing a second block 30b also in a top view, the position of the solid 44 and holding 46 portions is inverted along the direction 13.

Thus, all the blocks 30a, 30b of the radiation protection device 28 are of identical or substantially identical design, only their positioning differing depending on whether the block belongs to the first or the second annular radiation protection row.

Regarding the annular row of the second blocks 30b, the latter are also arranged in succession along the circumferential direction 13, so as to face each other in said direction, again in the single space 26. At least several of these second blocks 30b define circumferential inter-block gaps 50, each corresponding to a space left empty between two blocks 30b in direct succession along the direction 13. Preferably, such a gap 50 is provided on either side of each block 30b of the device 28, even though some blocks 30b could be in contact with each other in the direction 13, without leaving the scope of the invention.

To limit/prevent circumferential spacing between the adjacent second blocks 30b, and thus prevent the accumulation of such spacings from resulting in neutron leakages of an unacceptable level between two blocks 30b in direct succession, it is provided that several first blocks 30b, and preferably all or almost all of them, are each held on at least one of the two cowls 30, 32. For each of the second blocks 30b concerned, they are held here by the first holding member 36a housed in a first orifice 58a of this second block, passing through and aligned with a first orifice 38a of one of the adjacent first blocks 30a in the direction 8.

Furthermore, the second block 30b is also held by the second holding member 36b, which passes through a second orifice 58b of this second block, aligned with the second orifice 38b of one of the adjacent first blocks 30a in the direction 8. Here also, the passage is carried out with a gap along the radial direction 11, because the second orifice 58b of the block 30b has the same oblong shape of radially or substantially radially oriented length.

The first blocks 30a of the first annular row are thus circumferentially offset from the second blocks 30b of the second annular row axially covered by the first. This offset corresponds to half of the angular amplitude of each of these blocks 30a, 30b, generating a so-called “phase opposition” arrangement of the two rows. Thanks to this arrangement, each first block 30a thus covers, along the direction 8, one of the inter-block gaps 50 between two second blocks 30b in direct succession of the second row, in the same way as each second block 30b covers, again along the direction 8, one of the inter-block gaps 34 between two first blocks 30a in direct succession of the first row.

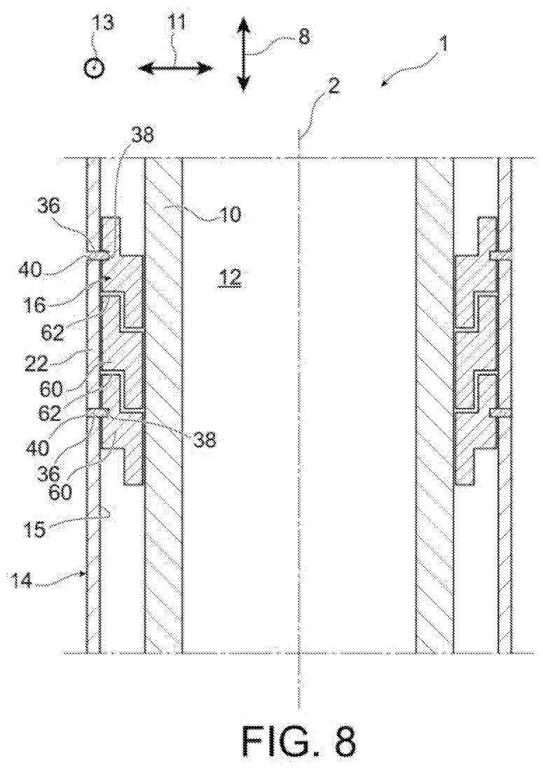

According to a second preferred embodiment of the invention shown in FIG. 8, the principle of the invention is implemented around the cavity 12 for housing the radioactive materials, at the aforementioned enclosure 14. Here, the enclosure 14 is formed using several enclosure wall elements delimiting the annular space 15, and being arranged about the axis 2. In particular, this involves the outer shell 22 and the lateral body 10 each in shroud form, and delimiting the single annular space 15 along a radial direction 11, respectively in the two opposite directions of this direction. Alternatively, as described with reference to FIG. 1, an inner shroud could be arranged around the lateral body 10 to delimit the space 15 radially inward. This single annular space 15 preferably extends over the entire height of the cavity 12, in the direction 8. Nevertheless, while retaining the principle of the second preferred embodiment which will be described hereinafter, the enclosure 15 could be segmented along the direction 8, and/or along the direction 13, so as to form several adjacent enclosures along one and/or the other of these two directions. Prefabricated radiation protection blocks 60 are arranged in succession along the direction 8, so as to face each other in said direction. Each of them takes the form of a thin ring, the rings then being arranged in succession in the direction 8, while revealing longitudinal inter-block gaps 62 between them. Each inter-block gap 62 corresponds to a space left empty between two blocks 60 in direct succession along the direction 8. Preferably, such a gap 62 is provided on either side of each block 60 of the device 16, even though some blocks could be in contact with each other in the direction 8, without leaving the scope of the invention. Here also, all the first blocks 60 are preferably identical or substantially identical. Generally, each block 60 is made of one piece, the half-section of which has a general Z-shape, with the central arm, oriented along the direction 11, which is orthogonal to the two other arms, oriented along the direction 8. This particular shape allows the blocks 60 in direct succession to partially overlap with each other, along the radial direction 11, in order to limit radiological leakages.

At least several of the blocks 60, i.e. for example all or most of them, or for example one block in two, are each held on the outer shell 22 by a holding member 36 in the form of a pin housed in an orifice 38 of the block 60, and also housed in an orifice 40 made on the outer shell 22. The pin 36 can be fastened in the orifice 40 preferably passing through the shell 22, and its other end is housed fastened or simply slotted in the preferably blind orifice 38 of the block 60. The pin 36 and its associated orifices 38, 40 are preferably oriented along the radial direction 11, or substantially along this direction.

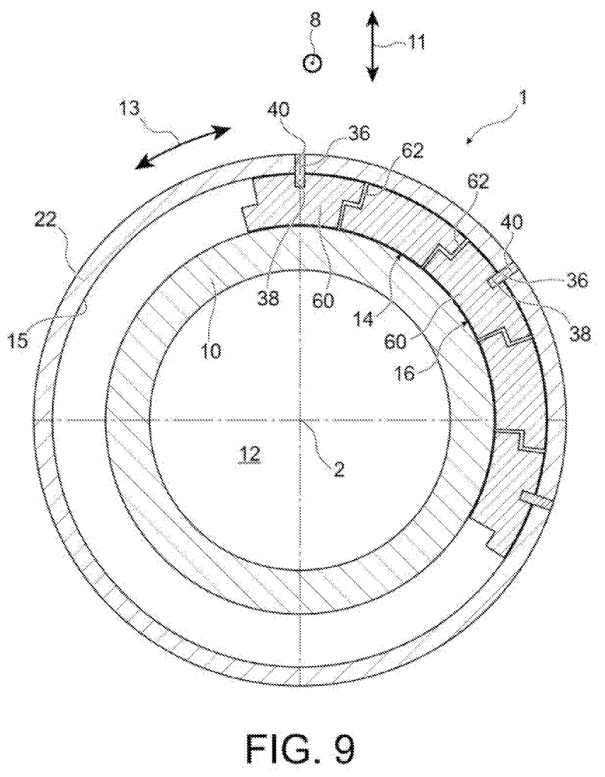

According to an alternative to the second preferred embodiment, seen in FIG. 9, the single annular space 15 is filled with blocks 60 each extending over the entire height of this space, forming a simple angular sector. The blocks 60 thus recreate a ring about the axis 2, arranged in succession along the direction 13 and forming circumferential inter-block gaps 62 between them. The blocks 60 are here also all preferably identical or substantially identical. Generally, each block 60 is made of one piece, the cross-section of which has a general Z-shape, with the central arm, oriented along the direction 11, which is orthogonal to the two other arms, oriented along the direction 13. This particular shape allows the blocks 60 in direct succession to partially overlap with each other, along the radial direction 11, in order to limit radiological leakages.

At least several of the blocks 60 are held in an identical or similar manner to that disclosed above, with the pins 36 radially passing through the holes 38, 40 provided respectively on the blocks 60 and on the outer shell 22.

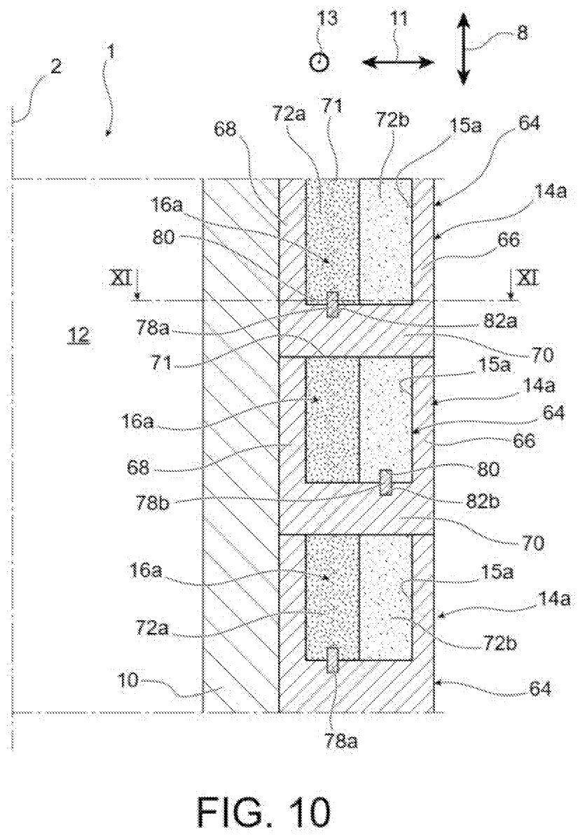

According to a third preferred embodiment of the invention shown in FIGS. 10 to 12, the principle of the invention is again implemented around the cavity 12 for housing radioactive materials, but with a radiological protection enclosure 14a in the form of a ring around the cavity 12, over a reduced height.

Indeed, several distinct annular enclosures 14a are arranged in succession along the direction 8 along the cavity 12, each of them essentially being formed using two enclosure wall elements 64 each taking an annular structure form, and stacked on top of each other along the direction 8. These accumulated enclosures 14a extend over the entire height of the cavity 12, or substantially over this entire height.

Each annular structure 64 is centered on the axis 2, and it comprises a radially outer portion 66, a radially inner portion 68, and a radial portion 70 extending radially from the radially outer portion to the radially inner portion 68. The general U-shaped half-section of the annular structure 64 delimits, opposite the radial portion 70 along the direction 8, an opening 71 which is sealed by the radial portion 70 of the annular structure 64 arranged in direct succession. The annular space 15a is thus delimited radially in both directions respectively by the two walls 66, 68 of one of the annular structures 64, and delimited axially in both directions respectively by the radial portion 70 of said structure 64, as well as by the radial wall 70 of the structure 64 arranged in direct succession in the stack along the direction 8.

Alternatively, each annular structure 64 may not comprise the radially inner portion 68, and therefore have a general L-shaped half-section. The radially inward delimitation of each annular cavity 15a is then carried out with the radially outer surface of the lateral container body 10. Similarly, it is stated that while the radial portion 70 is shown as planar, it could however comprise a step along the direction 8.

Any two annular structures 64 in direct succession in the direction 8 form a single space 15a also of annular geometry, even though a segmentation along the circumferential direction 13 remains possible, without leaving the scope of the invention.

The radiological protection device 16a housed in the space 15a of each enclosure 14a also consists of blocks, here first blocks 72a and second blocks 72b, respectively intended to form two concentric annular rows, centered on the axis 2. The first and second blocks 72a, 72b are preferably all of identical or substantially identical shape, for example generally parallelepiped, or having a slight curvature along the circumferential direction in order to adapt to the curvature of the single space 15a along said direction.

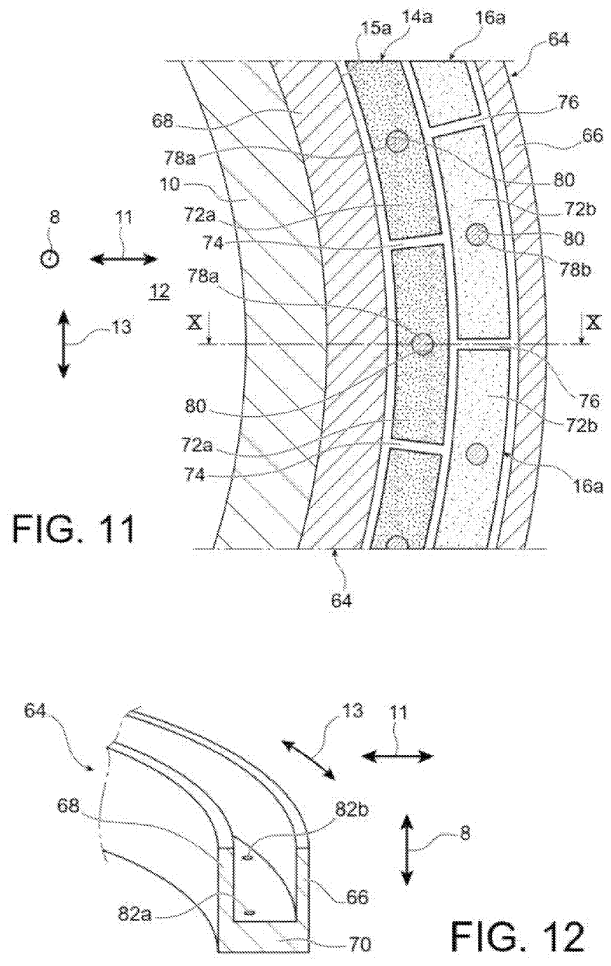

More specifically, the first prefabricated radiation protection blocks 72a form the inner row, and are arranged in succession along the direction 13 so as to face each other in said direction, and by revealing several circumferential inter-block gaps 74, in the same direction as that described above. Similarly, the second prefabricated radiological protection blocks 72b form the outer row, and are also arranged in succession along the direction 13 so as to face each other in said direction, and by revealing several circumferential inter-block gaps 76 seen in FIG. 11.

To ensure the holding of each of several of the first blocks 72a, or all of them, each of them is held relative to the radial portion 70 of the annular structure 64 wherein it rests, by a first holding pin 78a housed in an orifice 80 of the block 72a, and also housed in a first orifice 82a made on said radial portion 70 and opening into the single annular space 15a. The first pin 78a can be fastened or simply slotted into each of these two, preferably blind, orifices 80, 82a.

The pin 78a in the bottom of the space 15a, as well as its associated orifices 80, 82a, are preferably oriented along the longitudinal direction 8, or substantially along this direction. Similarly, to ensure the holding of each of several of the second blocks 72b, or all of them, each of them is held relative to the radial portion 70 of the annular structure 64 wherein it rests, by a second holding pin 78b housed in an orifice 80 of the block 72b, and also housed in a second orifice 82b made on the radial portion 70. Here too, the second pin 78b can be fastened or simply slotted into each of these two associated, preferably blind, orifices 80, 82b. The second pin 78b in the bottom of the space 15a, as well as its two associated orifices 80, 82b, are preferably also oriented along the longitudinal direction 8, or substantially along this direction.

The first blocks 72a of the first annular row are circumferentially offset from the second blocks 72b of the second annular row. This offset corresponds to half of the angular amplitude of each of these blocks 72a, 72b, generating a so-called “phase opposition” arrangement of the two rows. Thanks to this arrangement, each first block 72a thus covers, along the direction 11, one of the inter-block gaps 76 between two second blocks 72b in direct succession of the second row, in the same way as each second block 72b covers, again along the direction 11, one of the inter-block gaps 74 between two first blocks 72a in direct succession of the first row.

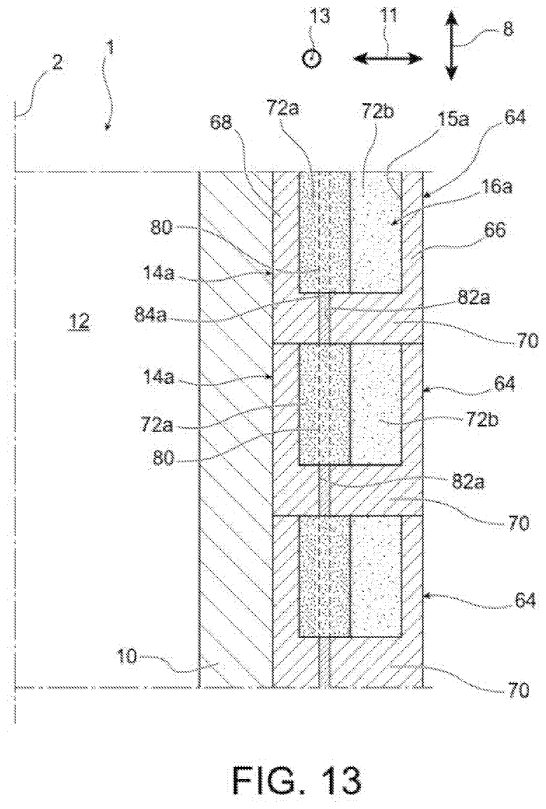

According to an alternative shown in FIG. 13, the same first through rod 84a, oriented along the direction 8, is used for holding a first block 72a of several stacked enclosures 14a. Indeed, this rod 84a passes through several first blocks 72a aligned along the direction 8 and belonging to distinct enclosures 14a. It may consist of a first block of all the annular enclosures 14a equipping the container 1. In such a case, at least some of the orifices 80, 82a are through to allow the rod 84a to pass. Several first rods 84a of this type can thus cooperate with the blocks 72a of the first row.

One or more second through rods (not shown) of the same type may be implemented to hold second blocks 72b of the second annular row.

Of course, various modifications may be made by a person skilled in the art to the invention just described, only by way of non-limiting examples and according to the scope defined by the appended claims. In particular, the different preferred embodiments described above may be combined, and their features remain interchangeable. For example, solutions involving blocks partially overlapping with each other, within the same row, may be replaced by solutions with two distinct rows of blocks overlapping with each other, and vice versa.

What is claimed is:

1. A container for transporting and/or storing radioactive materials, the container comprising a container body formed by a lateral body, a bottom and a removable lid, the bottom and the lid being spaced apart from each other along a longitudinal central axis of the container, and the body delimiting a cavity for housing the radioactive materials, the container including at least one radiological protection enclosure formed by enclosure wall elements, each radiological protection enclosure delimiting with its enclosure wall elements a single space wherein a radiological protection device is disposed,
wherein the radiation protection device includes a plurality of prefabricated radiation protection blocks arranged in succession along a given direction of the container, so as to face each other in said direction, within said single space,
at least several of said plurality of blocks being each held on at least one of the enclosure wall elements by at least one holding member cooperating with this block and with said at least one of the associated enclosure wall elements,
said plurality of prefabricated blocks defining, within said single space, several inter-block gaps along said given direction, each inter-block gap being defined between two blocks arranged in direct succession along said direction.

2. The container according to claim 1, wherein the radiological protection enclosure is located at the lid and it is formed by enclosure wall elements of the lid, said single space extending over a given angular amplitude along a circumferential direction of the container, first prefabricated radiation protection blocks being arranged in succession along the circumferential direction so as to face each other in said direction,
and in that at least several of said first blocks are each held on at least one of two enclosure wall elements of the lid delimiting said single space along a longitudinal direction of the enclosure and the container, respectively in the two opposite directions of this direction, holding being carried out by a first holding member housed in a first orifice of this first block, and also housed in a first orifice made on at least one of the two associated enclosure wall elements.

3. The container according to claim 2, wherein each first block held by its first associated holding member is also held by a second holding member housed in a second orifice of this first block, and also housed in a second orifice made on at least one of the two associated enclosure wall elements, said second orifice in the first block being preferably radially spaced apart from the first orifice in this first block.

4. The container according to claim 3, wherein the first and/or second orifice in the first held block is of oblong shape, the length of which is oriented radially or substantially radially, and preferably only that of the two orifices which is radially farthest away from the longitudinal central axis.

5. The container according to claim 2, wherein said single space also houses second prefabricated radiological protection blocks arranged in succession along the circumferential direction so as to face each other in said direction,
in that at least several of said second blocks are each held on at least one of the two enclosure wall elements of the lid by said first holding member housed in a first orifice of this second block, and also housed in said first orifice made on at least one of the two associated enclosure wall elements,
and in that each first block covers, along the longitudinal direction, an inter-block gap in said circumferential direction between two second blocks in direct succession, and vice versa.

6. The container according to claim 5, wherein the first and second blocks all have an identical design, the second blocks being arranged in said single space in an inverted position relative to the position of the first blocks.

7. The container according to claim 6, wherein each first and second block has an imaginary radial midline, delimiting, on either side circumferentially of this imaginary line, two block portions including a holding portion comprising the first orifice, this first orifice being arranged along an imaginary radial midline of this holding portion.

8. The container according to claim 2, wherein said single space extends over an angular amplitude of 360° along the circumferential direction.

9. The container according to claim 1, wherein the radiological protection enclosure is located around the cavity for housing the radioactive materials.

10. The container according to claim 9, wherein the enclosure wall elements are arranged about the longitudinal central axis, said single space extending over a given height along the longitudinal direction of the container, prefabricated radiological protection blocks being arranged in succession along the longitudinal direction so as to face each other in said direction,
and in that at least several of said blocks are each held on at least one of two enclosure wall elements delimiting said single space along a radial direction of the enclosure and the container, respectively in the two opposite directions of this direction, holding being carried out by a holding member housed in an orifice of the block, and also housed in an orifice made on at least one of the two associated enclosure wall elements.

11. The container according to claim 10, wherein the two enclosure wall elements respectively form an inner shroud and an outer shroud centered on the longitudinal central axis.

12. The container according to claim 11, wherein the blocks in direct succession in the longitudinal direction partially overlap with each other along the radial direction.

13. The container according to claim 9, wherein the radiological protection enclosure comprises two enclosure wall elements each adopting an annular structure form and being stacked along the longitudinal direction, each annular structure centered on the longitudinal central axis comprising a radially outer portion, and a radial portion extending radially from the radially outer portion toward the longitudinal central axis and delimiting said single space along the longitudinal direction, the annular structure delimiting an opening opposite the radial portion along the longitudinal direction, this opening being sealed by the radial portion of the other annular structure,
said single space extending over a given angular amplitude along a circumferential direction of the enclosure and the container, the first prefabricated radiological protection blocks being arranged in succession along the circumferential direction so as to face each other in said direction,
and in that at least several of said first blocks are each held on at least one of the two enclosure wall elements in annular structure form, holding being carried out by a first holding member housed in an orifice of the first block, and also housed in a first orifice made on at least one of the two associated wall elements, preferably on the radial portion of at least one thereof.

14. The container according to claim 13, wherein said single space also houses second prefabricated radiological protection blocks arranged in succession along the circumferential direction so as to face each other in said direction,
in that at least several of said second blocks are each held on at least one of the two enclosure wall elements in annular structure form, by a second holding member housed in an orifice of this second block, and also housed in a second orifice made on at least one of the two associated wall elements, preferably on the radial portion of at least one thereof,
and in that each first block covers, along the radial direction, an inter-block gap in said circumferential direction between two second blocks in direct succession, and vice versa.

15. The container according to claim 14, wherein the first and/or second holding member is in the form of a pin or a through rod.
